(19) United States
(12) Patent Application Publication
(10) Pub. No.: US 2020/0161675 A1
(43) Pub. Date: May 21, 2020

(54) FUEL CELL SYSTEM WITH AN ANNULAR REFORMER

(71) Applicant: AVL List GmbH, Graz (AT)

(72) Inventors: Vincent LAWLOR, Graz (AT); Michael REISSIG, Graz (AT); Jörg MATHÉ, Graz (AT); Julian MAKINSON, Graz (AT); Bernd REITER, Kainbach bei Graz (AT); Thomas KRAUSS, Graz (AT)

(73) Assignee: AVL List GmbH, Graz (AT)

(21) Appl. No.: 16/605,006

(22) PCT Filed: Apr. 13, 2018
(86) PCT No.: PCT/EP2018/059539

§ 371 Date: Oct. 13, 2019

(30) Foreign Application Priority Data
Apr. 13, 2017 (AT) A50311/2017

(51) Int. Cl. H01M 8/04014; H01M 8/04225; H01M 8/0612; H01M 8/0432

(52) U.S. Cl. CPC H01M 8/04022; H01M 8/04225; H01M 2250/20; H01M 8/04343; H01M 8/0435; H01M 8/0618

(57) ABSTRACT

This invention concerns a fuel cell system (100a; 100b; 100c) comprising a fuel cell stack (1) having an anode portion (2) and a cathode portion (3), a reformer (4) for supplying reformed anode gas to the anode portion (2), and an exhaust gas burner (5) for burning anode exhaust gas from the anode portion (2) and/or cathode exhaust gas from the cathode portion (3), wherein the reformer (4) is arranged at least in sections annularly around the exhaust gas burner (5), wherein an inner wall portion of the reformer (4) is arranged completely or at least substantially around an outer wall portion of the exhaust gas burner (5). The invention also concerns a method for operating a fuel cell system conforming to the invention (100a; 100b; 100c) and a motor vehicle (1000) with a fuel cell system conforming to the invention (100a; 100b; 100c).

The present invention relates to a fuel cell system, in particular a SOFC system, comprising a fuel cell stack having an anode portion and a cathode portion, a reformer for supplying reformed anode gas to the anode portion, and an exhaust gas burner for burning anode exhaust gas from the anode portion and/or cathode exhaust gas from the cathode portion. The invention also relates to a method for operating a SOFC system and a motor vehicle equipped with such a SOFC system.

Document AT 513 932 A1 results in a catalyst unit for a high-temperature fuel cell system or an SOFC system with a reformer catalyst of a reformer for the preparation of a fuel for a fuel cell and an oxidation catalyst of an exhaust gas burner for the exhaust aftertreatment of the fuel cell. According to document AT 513 932 A1, the oxidation catalyst is arranged in an annular formation around the cylindrical reformer catalyst. The gas paths of the oxidation catalyst and the reformer catalyst are separated by a metal tube containing the reformer catalyst, the metal tube having a sleeve forming a housing for the reformer catalyst and an inner tube forming the inner wall of the annular oxidation catalyst. Such an arrangement allows an effective heat transfer between the reformer catalyst and the oxidation catalyst or between the reformer and the exhaust burner to be realized in a compact manner. For additional heating of the oxidation catalytic converter, a start burner is arranged in the fuel cell system, which can addi-tionally heat or preheat the oxidation catalytic converter, especially during start operation of the fuel cell system. It is desirable, especially for mobile purposes, to keep the number of components and thus the size and weight of a fuel cell system as small or low as possible.

From document WO 2013/187154 A1 a fuel cell module with an exhaust gas burner and a reformer are disclosed. The reformer has several reformer lines which run parallel to a longi-tudinal direction of the exhaust gas burner and at a distance from it. The fuel cell module also has an evaporator and a heat exchanger which are connected to each other via a pipe system in fluid and/or heat connection. The exhaust burner, the reformer, the evaporator and the heat exchanger require a relatively complex piping system and a correspondingly complicated struc-ture of the fuel cell module.

The object of this invention is to at least partially take into account the problems described above. In particular, it is the object of the present invention to create a fuel cell system, a method for operating the fuel cell system and a motor vehicle with the fuel cell system, in which an effective heat transport between exhaust burner, reformer, heat exchanger and/or evaporator can be realized in a compact and simple manner, whereby the fuel cell system can be brought to operating temperature in a fast and efficient manner, especially during a start process.

The preceding object is solved by the claims. In particular, the preceding object is solved by the fuel cell system according to claim 1, the method according to claim 8 and the motor vehicle according to claim 10. Further advantages of the invention result from the dependent claims, the description and the drawings. Features and details which are described in connection with the fuel cell system naturally also apply in connection with the method in accordance with the invention, the motor vehicle in accordance with the invention and vice versa in each case, so that with regard to the disclosure of the individual aspects of the invention, reference is or can always be made to each other.

According to a first aspect of the present invention, a fuel cell system is provided with a fuel cell stack comprising an anode portion and a cathode portion. The fuel cell system further comprises a reformer for supplying reformed anode gas to the anode portion and an exhaust gas burner for burning anode exhaust gas from the anode portion and/or cathode exhaust gas from the cathode portion. The reformer is arranged annularly around the exhaust gas burner at least in sections, an inner wall portion of the reformer being arranged completely or at least substantially around an outer wall portion of the exhaust gas burner.

During experiments within the scope of the present invention, it turned out surprisingly that the direct arrangement of the reformer around the exhaust burner described above leads to an advantageous heating arrangement in the fuel cell system. An effective heat transport from the exhaust gas burner into the reformer can be realized between the exhaust gas burner and the reformer arranged directly in an annular formation around it, especially for a start process of the fuel cell system. The reformer prefers to border directly on the fuel gas burner, at least in sections, especially in full. This means that the exhaust gas burner and the reformer are only separated from each other by a partition wall portion of the reformer and/or the exhaust gas burner.

The exhaust burner is preferably cylindrical in shape. The reformer is preferably configured in the form of a hollow cylinder and is arranged at least in sections in a precisely fitting annularly around the exhaust gas burner. i.e., the cylindrical exhaust gas burner has an outer circumferential portion formed correspondingly to an inner circumferential portion of the hollow cylindrical reformer, said outer circumferential portion of the exhaust gas burner being disposed on the correspondingly formed inner circumferential portion of the reformer. This not only allows a compact configuration of the exhaust gas burner reformer unit to be achieved. In addition, this can also enable effective heat transfer between the reformer and the exhaust burner. The exhaust gas burner is preferably configured at least in sections in the form of a straight circular cylinder or essentially in the form of a straight circular cylinder. The reformer preferably has a hollow cylinder with an appropriate receiving section for receiving the exhaust gas burner. Nevertheless, the reformer and the exhaust burner are not limited to the shape of a straight circular cylinder or a corresponding hollow cylinder.

The fact that the reformer is arranged annularly around the exhaust gas burner at least in sections means in particular that the reformer is not arranged around the exhaust gas burner over its entire length and around the exhaust gas burner at least in sections in the axial direction of the exhaust gas burner around the entire circumference of the exhaust gas burner.

The fuel cell system is preferably in the form of a SOFC system with a fuel source and an oxygen source. The fuel source is arranged to provide fuel for the anode portion. The oxygen source is arranged to provide oxygen for the cathode portion. Within the scope of the invention, the oxygen source can be configured to provide an oxygen-containing fluid (gaseous or liquid) such as air, in particular ambient air. The fuel source provides a fuel, in particular a liquid fuel, or a fuel-water mixture, in particular a liquid fuel.

The fuel cell stack can have several stacking units. In other words, this invention is not limited to a fuel cell system with a single fuel cell stack. Rather, the fuel cell system can have a plurality of fuel cell stacks.

The exhaust gas burner may have heat conducting elements on an outer circumferential surface of the exhaust gas burner which protrude from the outer circumferential surface of the exhaust gas burner into the reformer or into a fluid conducting portion of the reformer. This improves heat transfer between the reformer and the exhaust burner. The thermal conduction elements can be in the form of fins and/or ribs. By having fins and/or ribs on the outer circumferential surface of the exhaust gas burner, the heat transfer between the reformer and the exhaust gas burner can be improved in a simple and cost-effective way. As an alternative or in addition to the ribs and/or fins, a helical rib may be fitted to the exhaust gas burner which completely encompasses the exhaust gas burner on the outer circumferential surface of the out-let burner in the axial direction of the exhaust gas burner. As a result, the path that the anode gas travels at the hot exhaust gas burner can be lengthened and a correspondingly effective heat transfer between the exhaust gas burner and the reformer can be achieved.

According to a further embodiment of the present invention, it is possible that in a fuel cell system an evaporator for evaporating anode gas is arranged downstream of the exhaust gas burner and upstream of the reformer and a heat exchanger is arranged downstream of the evaporator, whereby the heat exchanger for heating the reformer or anode gas is arranged in the reformer, on the reformer or in the vicinity of the reformer. The evaporator is preferably located directly behind or after the exhaust gas burner. By placing the evaporator directly downstream of the exhaust burner, the anode gas flowing through the evaporator towards the reformer can be effectively heated or overheated. As the exhaust gas from the exhaust gas burner is led via the evaporator to the heat exchanger located on the reformer, the anode gas can also be heated or overheated there by the exhaust gas from the exhaust gas burner before the exhaust gas is led out into the surroundings of the fuel cell system. For heating the anode gas by the exhaust gas of the exhaust gas burner, a first fluid line portion of the evaporator through which the exhaust gas flows from the exhaust gas burner is in thermal communication with a second fluid line portion of the evaporator through which the anode gas flows.

Anode gas is, in particular a liquid or gaseous hydrocarbon, supplied to the reformer from a fuel source via the evaporator in order to be conveyed by the reformer to the anode portion. The fuel can contain hydrogen, ethanol, methane or diesel. In addition, exhaust gas in the context of this disclosure is understood to mean anode and/or cathode exhaust gas which is burnt in the exhaust gas burner, generating heat which is then available as a heat source in the evaporator. After the evaporator, the exhaust gas is conveyed through a heat exchanger, which also removes heat from the (burnt) exhaust gas and releases it into the environment. The anode exhaust gas contains fuel and other components that have not yet been converted after the fuel stack are converted in the exhaust gas burner. The cathode exhaust gas consists essentially, in particular exclusively, of air or an oxygen-containing fluid.

It is also possible that in a fuel cell system according to the present invention a starting burner is arranged upstream of the exhaust gas burner. It may be provided that the exhaust gas burner is directly connected to the starting burner. Using the start burner, the exhaust burner or exhaust gas in the exhaust burner can be heated particularly quickly during a start process. The fuel cell system can therefore be started quickly and efficiently. In an inventive fuel cell system, the starting burner can be positioned particularly easily on the cylindrical exhaust burner. It is also conceivable to integrate the start burner into the exhaust burner, which is placed inside the reform ring.

In one embodiment, the exhaust gas burner and the starting burner are configured as a common or integral component. Such a common burner would advantageously include a catalytic material, whereby an additional air supply may be provided. For example, a burner that can function both as a starting burner and as an exhaust gas burner may have two or more combustion chambers.

In the context of the invention, the starting burner is understood to be a starting burner for heating the fuel cell system and/or the individual components of the fuel cell system. During a cold start of the fuel cell system, when the exhaust gas burner is still cold and is therefore not suitable for heating the fuel cell system and/or maintaining an operating temperature, the start burner can be used to heat the fuel cell system to an operating temperature.

After the start burner has been put into operation, this hot exhaust gas conveys via the anode and cathode sides of the system. When the operating temperature of the fuel cell stack is reached, an anode current can be activated, i.e. fuel can be fed to the anode via an anode path. At the same time, the fuel supply to the starting burner is deactivated, so that it is no longer operated or is passively operated. Now anode exhaust gas is burned in the exhaust gas burner under supply of cathode exhaust gas (air).

Furthermore, it can be advantageous for an inventive fuel cell system if the starting burner has a starting burner injector for injecting fuel into the starting burner. This allows a fuel-air mixture in the starting burner to be quickly and easily adjusted to a desired stoichiometric mixing ratio. Thus, a first, for example sub-stoichiometric mixing ratio, can be set during a startup process of the fuel cell system and then a second, for example stoichiometric or super-stoichiometric mixing ratio, can be set quickly and easily. With the aid of the start burner injector, a fast and efficient start process of the fuel cell system can be facilitated in a simple manner. The term “fuel” is used here to refer preferably to a fluid containing hydrogen or hy-drocarbons. During the heating process of the fuel cell system, fuel is burned in the starting burner by supplying air or an oxygen-containing fluid. It may be provided that the starting burner comprises a catalytic material or is catalytically coated.

In addition, in a fuel cell system according to the present invention, it is possible that the exhaust burner for the combustion of the anode exhaust gas and/or the cathode exhaust gas has an exhaust burner catalyst, in particular a cylindrical oxidation catalyst. Using the exhaust gas burner catalyst, the exhaust gas burner can basically function self-sufficiently or essentially self-sufficiently. Accordingly, auxiliary equipment such as supply lines to the exhaust gas burner for the combustion of the exhaust gas could be dispensed with. This means that the exhaust burner can be provided in a particularly space-saving manner. Furthermore, the degree of complexity of the fuel cell system can be kept low. In the context of this invention, it has proved to be particularly advantageous if, in addition to the exhaust gas burner catalyst, the exhaust gas burner also has an electrical heating medium for additional heating of the anode exhaust gas and/or the cathode exhaust gas. By means of the electrical heating medium, the exhaust gas burner can first be brought to a pre-defined operating temperature so that it can then function with the appropriate efficiency. In a preferred embodiment, the exhaust gas burner catalytic converter can be configured as a coating for the electrical heating medium. This means that the exhaust gas burner can be made available in a particularly space-saving manner. The exhaust burner particularly prefers an electrical heating medium, if this is integrally formed with the starting burner. The exhaust gas burner is configured to completely burn fuel not completely burnt in the anode portion of the fuel cell stack by supplying cathode exhaust gas, especially air. For this purpose, the exhaust gas burner comprises in particular a catalytic material or is catalytically coated. The exhaust gas burner is therefore to be understood as an afterburner in the context of the invention.

In the case of an inventive fuel cell system, it may also be advantageous if the reformer for reforming the anode gas has a reformer catalyst, in particular an annular oxidation catalyst, which is arranged at least partially around the exhaust burner portion and/or the exhaust burner catalyst. With regard to the advantages of the reformer catalytic converter, the same applies as described above for the exhaust burner catalytic converter. In an inventive fuel cell system, it is particularly advantageous if the annular reformer catalyst, which is arranged in the correspondingly configured reformer, is positioned annularly around the cylindrical exhaust burner catalyst, which is arranged in the correspondingly configured exhaust burner, i.e. when the reformer catalyst is arranged at least partially coaxial to the exhaust burner catalyst. With such an arrangement, a particularly effective heat transport between the corresponding portions of the exhaust gas burner and the reformer can be achieved.

In a further embodiment of the present invention, it is possible that in a fuel cell system the exhaust gas burner for the combustion of the anode exhaust gas and/or the cathode exhaust gas has an exhaust gas burner injector for injecting fuel into the exhaust gas burner. By means of the exhaust gas burner injector, a fuel-air mixture in the exhaust gas burner can be quickly and easily adjusted to a desired stoichiometric mixing ratio. In particular, it is possible to inject metered amounts of fuel into the exhaust gas burner in order to temporarily increase a combustion temperature in the exhaust gas burner, for example during a startup process of the fuel cell system. In the case of a fuel cell system according to the present invention, it is particularly easy to position the exhaust gas burner injector on the cylindrical exhaust gas burner.

According to a further aspect of the present invention, a method of operating a fuel cell system as described in detail above is provided. Thus, a procedure according to the invention has the same advantages as described in detail with regard to the fuel cell system according to the invention. As part of the method, a sub-stoichiometric fuel-air mixture is combusted in the start burner in a predefined time window during start-up operation of the fuel cell system. This allows the exhaust burner to be heated efficiently.

In addition, it is possible that a sub-stoichiometric fuel-air mixture is burned in a pre-defined time window during start-up operation of the fuel cell system as part of a catalytic partial oxidation in a procedure in accordance with the invention in the reformer. This adds heat to the reformer, allowing the reformer to be heated particularly effectively during the start-up process of the fuel cell system. In addition, the anode can be protected from oxidation by air or oxygen by CPDX operation or by catalytic partial oxidation in the reformer.

According to another aspect of the present invention, a motor vehicle with a fuel cell system as described in detail above is provided to power at least one drive unit of the motor vehicle. Thus, a motor vehicle in conformity with the invention has the same advantages as those described in detail above.

Further measures to improve the invention result from the following description of various embodiments of the invention, which are shown schematically in the figures. All features and/or advantages resulting from the claims, the description or the drawing, including construc-tive details and spatial arrangements, may be essential to the invention both in themselves and in the various combinations.

They show schematically in each case:

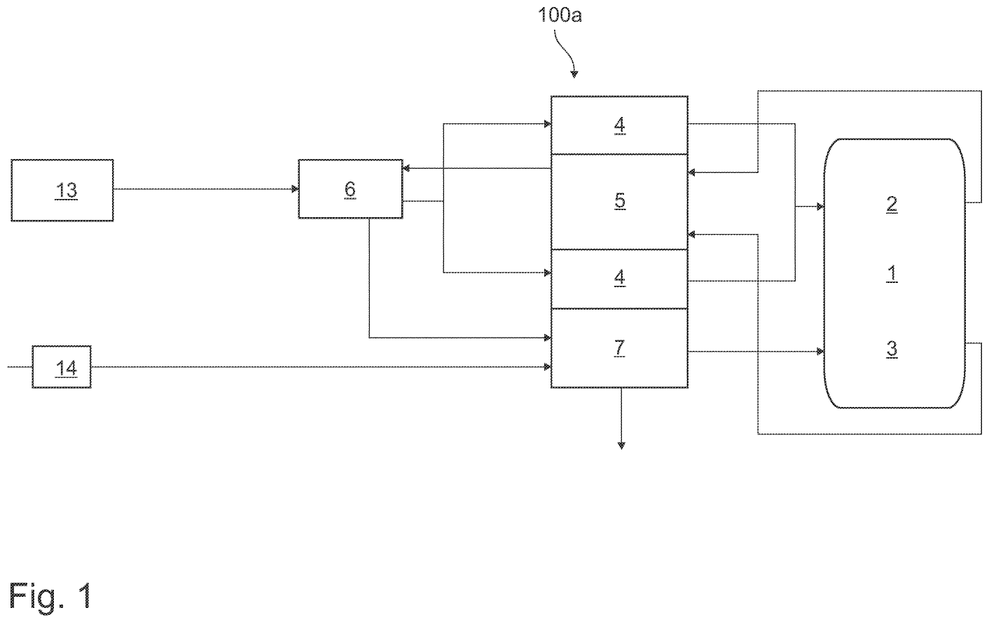

FIG. 1 A fuel cell system according to a first embodiment of the present invention,

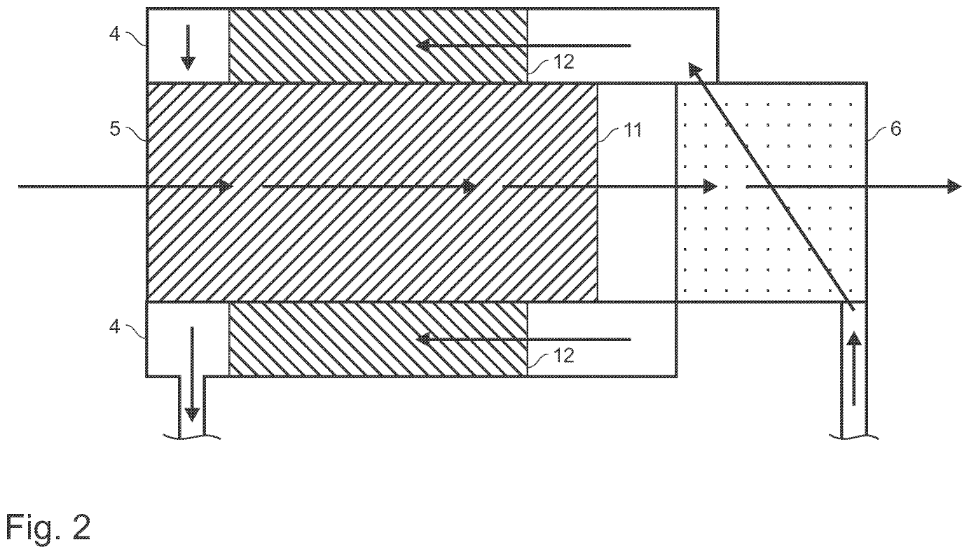

FIG. 2 An exhaust gas burner reformer unit with an integrated evaporator in a fuel cell system according to the first embodiment of the present invention,

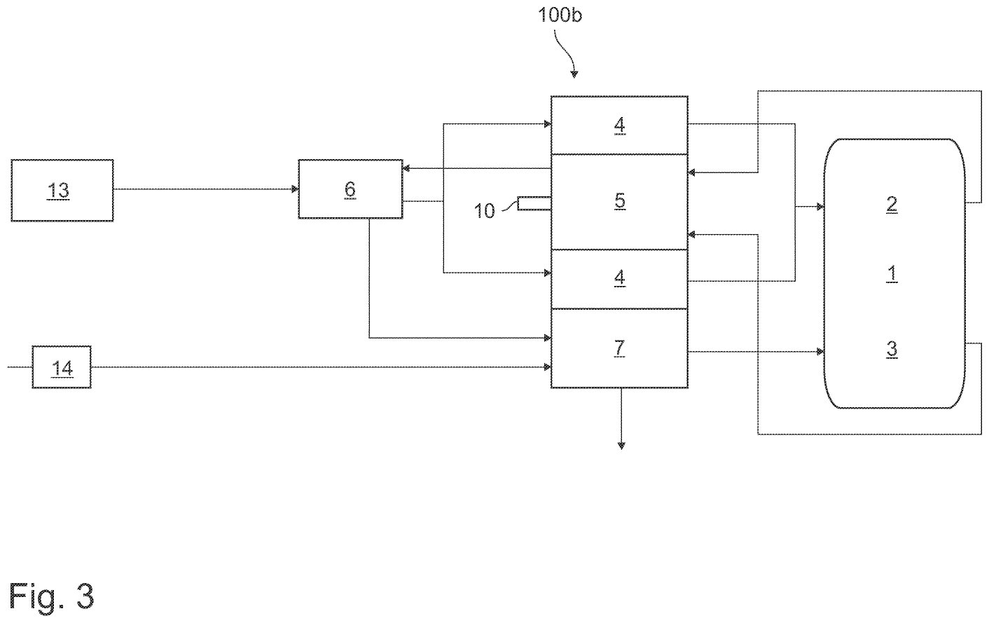

FIG. 3 A fuel cell system according to a second embodiment of the present invention,

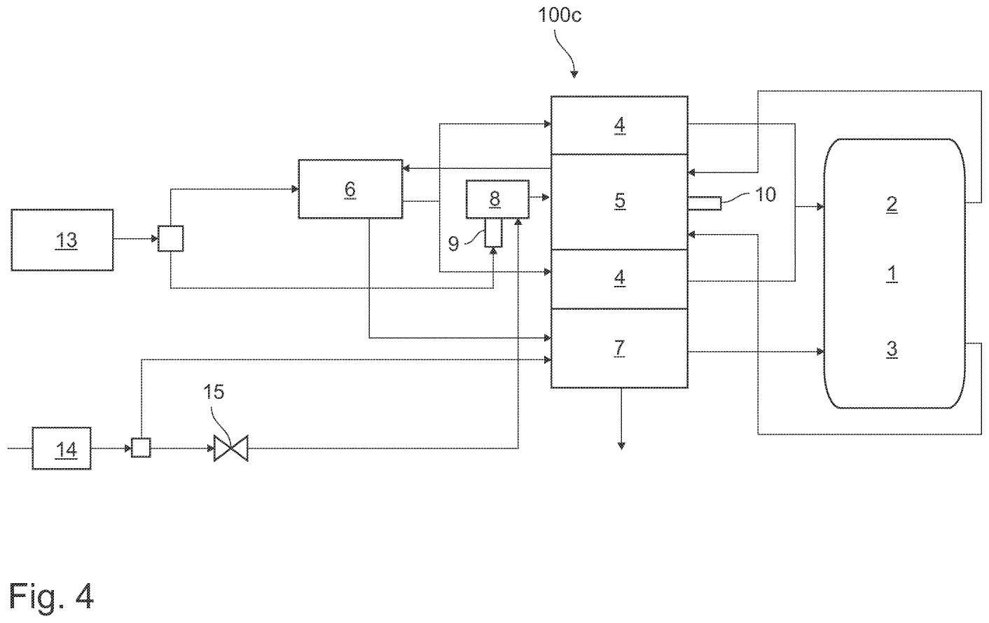

FIG. 4 A fuel cell system according to a third embodiment of the present invention, and

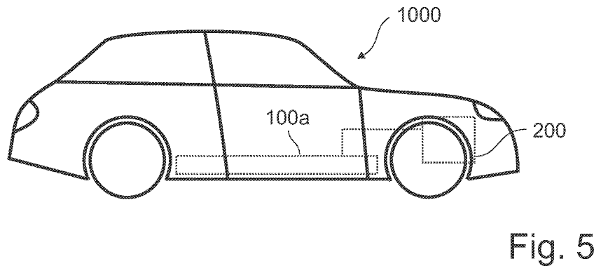

FIG. 5 A motor vehicle equipped with a fuel cell system in accordance with the present invention.

Elements with the same function and mode of action have the same reference signs in FIGS. 1 to 5.

FIG. 1 schematically shows a fuel cell system 100a according to a first embodiment. The fuel cell system 100a is configured in the form of a SOFC system and has a fuel source 13 in the form of a fuel tank and an oxygen source 14 in the form of a blower.

The fuel cell system 110a further comprises a fuel cell stack 1 having an anode portion 2 and a cathode portion 3, a reformer 4 for supplying reformed anode gas to the anode portion 2, and an exhaust gas burner 5 for burning anode exhaust gas from the anode portion 2 and cathode exhaust gas from the cathode portion 3. The reformer 4 is arranged annularly around the exhaust gas burner 5, wherein an inner wall portion of the reformer 4 is arranged entirely or at least substantially entirely around an outer wall portion of the exhaust gas burner 5 (explained in more detail with respect to FIG. 2).

As shown in FIG. 1, an evaporator 6 for evaporating anode gas is arranged downstream of the exhaust gas burner 5 and upstream of the reformer 4. A heat exchanger 7 is arranged downstream of the evaporator 6, the heat exchanger 7 being arranged on the reformer 4 for heating the reformer 4 or anode gas in the reformer 4. In accordance with the embodiment shown in FIG. 1, exhaust gas from the exhaust gas burner 5 can thus be conveyed directly via the evaporator 6 to the heat exchanger 7 and from there to the surroundings of the fuel cell system 100a.

Fuel or anode gas can be conveyed from the fuel source 13 via the evaporator 6 to the annular reformer 4 and from there as reformed anode gas to the anode portion 2. Air or an oxygen-containing fluid can be conveyed from the oxygen source 14 via the heat exchanger 7 to the cathode portion 3.

In FIG. 2 the reformer 4, the exhaust burner 5 and the evaporator 6 are shown schematically according to a preferred embodiment. As can be seen in FIG. 2, the evaporator 6 is arranged directly downstream of the exhaust gas burner 5. Furthermore, FIG. 2 shows that the reformer 4 has an annular reformer catalyst 12 which is arranged corresponding to a passage volume of the reformer 4 in it. It is further represented that the exhaust gas burner 5 for burning the anode exhaust gas and the cathode exhaust gas comprises a cylindrical exhaust gas burner catalyst 11 in the form of an oxidation catalyst arranged corresponding to a passage volume of the exhaust gas burner 5 therein. The exhaust burner catalytic converter 11 and the reformer catalytic converter 12 are only separated from each other by a partition wall of the reformer 4 and the exhaust burner 5 respectively. The reformer catalytic converter 12 is arranged over its entire length around the exhaust burner catalytic converter 11. This enables particularly good heat transfer from the exhaust gas burner 5 or the exhaust gas burner catalyst 11 to the reformer 4 or the reformer catalyst 12.

With reference to FIG. 3, a fuel cell system 100b is then described according to a second embodiment. The fuel cell system 100b according to the second embodiment essentially corre-sponds to the fuel cell system 100a according to the first embodiment. To avoid a redundant description, only the distinguishing features according to the second embodiment are subsequently described.

In the fuel cell system 100b shown in FIG. 3, the exhaust gas burner 5 has an exhaust gas burner injector 10 for injecting fuel into the exhaust gas burner 5 for the combustion of the anode exhaust gas and the cathode exhaust gas.

With reference to FIG. 4, a fuel cell system 100c is then described according to a third embodiment. The fuel cell system 100c according to the third embodiment essentially corre-sponds to the fuel cell system 100a according to the first embodiment and the fuel cell system 100b according to the second embodiment. In order to avoid a redundant description, only the distinguishing features according to the third embodiment are subsequently described.

In the fuel cell system 100c shown in FIG. 4, a starting burner 8 for heating cathode exhaust gas and anode exhaust gas flowing in the direction of the exhaust gas burner 5 is arranged upstream of the exhaust gas burner 5. The starting burner 8 has a starting burner injector 9 for injecting fuel into the starting burner 8. The starting burner 8 or the starting burner injector 9 can be supplied with fuel from the fuel source 13 and with oxygen, especially air, from the oxygen source 14. For a metered supply of oxygen from the oxygen source 14 to the starting burner 8, a metering valve 15 is arranged in an oxygen line upstream of the starting burner 8 and downstream of the oxygen source 14.

With reference to FIG. 4, a method for operating the illustrated fuel cell system 100c during a startup process of the fuel cell system 100c is then described.

When the fuel cell system is started, an oxygen-containing fluid, in particular air, is supplied to the starting burner 8 from the fuel source 13 fuel and from the oxygen source 14. This means that an appropriate fuel-air mixture can be burned in the starting burner 8 to heat the exhaust gas burner 5. During start-up operation of the fuel cell system, a sub-stoichiometric fuel-air mixture is burned in the start burner 8. In a predefined time window during the start-up operation of the fuel cell system 100c, a sub-stoichiometric fuel-air mixture is also combusted in reformer 4 as part of a catalytic partial oxidation. The temperature in the fuel cell system 100c, in particular at the reformer 4, at the exhaust gas burner 5 and/or at the fuel cell stack 1 is determined. As soon as the determined temperature at reformer 4, exhaust gas burner 5 and/or fuel cell stack 1 exceeds a predefined threshold value, the start burner 8 is deactivated. I.e. a supply of fuel and oxygen is stopped.

FIG. 4 shows a motor vehicle 1000 with a fuel cell system 100a for supplying energy to a drive unit 200 in the form of an electric motor of the motor vehicle 1000.

### REFERENCE CHARACTER LIST

1 Fuel cell stack
2 Anode portion
3 Cathode portion
4 Reformer
5 Exhaust burner
6 Evaporator
7 Heat exchanger
8 Start burner
9 Start burner injector
10 Exhaust gas burner injector
11 Exhaust Burner Catalyst
12 Reformer catalytic converter
13 Fuel source
14 Oxygen source
15 Dosing valve
100a-100c Fuel cell system
200 Drive unit
1000 Motor vehicle

1. A fuel cell system comprising a fuel cell stack having an anode portion and a cathode portion, a reformer for supplying reformed anode gas to the anode portion, and an exhaust gas burner for burning at least anode exhaust gas from the anode portion or cathode exhaust gas from the cathode portion,
wherein
the reformer is arranged at least in sections annularly around the exhaust gas burner, wherein an inner wall portion of the reformer is arranged completely or at least substantially around an outer wall portion of the exhaust gas burner.

2. The fuel cell system according to claim 1,
wherein
an evaporator for evaporating anode gas is arranged downstream of the exhaust gas burner and upstream of the reformer, and a heat exchanger is arranged downstream of the evaporator, the heat exchanger being arranged on the reformer or in the vicinity of the reformer for heating the reformer or anode gas in the reformer, respectively.

3. The fuel cell system according to claim 1,
wherein
a starting burner is arranged upstream of the exhaust gas burner.

4. The fuel cell system according to claim 1,
wherein
the starting burner has a starting burner injector for injecting fuel into the starting burner.

5. The fuel cell system according to claim 1,
wherein
the exhaust gas burner has an exhaust gas burner catalytic converter, in particular a cylindrical oxidation catalytic converter, for the combustion of at least the anode exhaust gas or the cathode exhaust gas.

6. The fuel cell system according to claim 1,
wherein
the reformer for reforming the anode gas has a reformer catalytic converter, in particular an annular oxidation catalytic converter, which is arranged at least in sections around at least the exhaust gas burner or the exhaust gas burner catalytic converter.

7. The fuel cell system according to claim 1,
wherein
the exhaust gas burner for burning at least the anode exhaust gas or the cathode exhaust gas has an exhaust gas burner injector for injecting fuel into the exhaust gas burner.

8. A method of operating a fuel cell system according to claim 3 comprising a starting burner,
wherein
a sub-stoichiometric fuel-air mixture is combusted in the starting burner in a predefined time window during start operation of the fuel cell system.

9. The method according to claim 8,
wherein
in the reformer in a predefined time window during a start-up operation of the fuel cell system a sub-stoichiometric fuel-air mixture is burned as part of a catalytic partial oxidation.

10. A motor vehicle having a fuel cell system for supplying power to at least one drive unit of the motor vehicle, the fuel cell system comprising a fuel cell stack having an anode portion and a cathode portion, a reformer for supplying reformed anode gas to the anode portion, and an exhaust gas burner for burning at least anode exhaust gas from the anode portion (2) or cathode exhaust gas from the cathode portion,
wherein
the reformer is arranged at least in sections annularly around the exhaust gas burner, wherein an inner wall portion of the reformer is arranged completely or at least substantially completely around an outer wall portion of the exhaust gas burner.
